(19) United States
(12) Patent Application Publication
(10) Pub. No.: US 2016/0076715 A1
(43) Pub. Date: Mar. 17, 2016

(54) Directional flashlight

(71) Applicant: Bijan Dokhanian, Beverly Hills, CA (US)

(72) Inventors: Bijan Dokhanian, Beverly Hills, CA (US); Zoltan Kemeny, Chandler, AZ (US)

(21) Appl. No.: 14/757,108

(22) Filed: Nov. 19, 2015

(51) Int. Cl. F21L 4/00; F21V 8/00; F21V 14/04

(52) U.S. Cl. CPC F21L 4/005; F21V 14/045; G02B 6/0005

(57) ABSTRACT

Disclosed is an electrical hand held and battery operated searchlight torch, having means to shine at least part of its emitted light away from a single direction and thereby shining light at least more than one direction forward. One configuration comprises directional reflector heads switchable individually. Another configuration comprises flexible light guides, which may be collimated forward or let spread light diffuse. Searching with such novel searchlight in darkness can be safer than with state-of-art single directional torches, for projecting light on where one is stepping and let monitor the surrounding at least in a dim haze of light, without the need to bounce light away from the target at times, just to see the surrounding as well.

### FIELD OF THE INVENTION

This invention relates to flashlight with means to direct light in other directions than forward.

### BACKGROUND OF THE INVENTION

The invention fulfills the need for a flashlight which not only reflects forward, but some other preferred directions as well, for instance upward or downward or left or right or all the above, selectively or concurrently. Searching with a flashlight, by night, while walking or running, would require frequently moving the search light forward and down, for not to tumble on something, or up to see the cave ceiling, or sideways to see the walls around and get a sense of the surrounding.

Torch light, helping in such searches without directing the light to these directions and only see one of the targets at the time, but not concurrently, as one could see in daylight, would be a great service to campers, explorers, troops and many others. In fact, wide angle searchlights, up to at least 180°, could have lifesaving use in dire situation.

Therefore, it is the objective of the invention is to provide for such torch light, with means to adjust the light intensity and direction forward and in other directions all around, except backward.

### SUMMARY OF THE INVENTION

The above problems and others are at least partially solved and the above objects and others realized in a process, which according to the teachings of this invention, uses a flashlight device having means to direct its light at least in part away from the main direction, which is aligned with the body of said device.

In particular, according to one preferred embodiment of the invention, reflector heads are mounted over the tip of said body, most of which may be turned away from said main direction.

According to another preferred embodiment, transparent light guiding flexible tubing or filaments are affixed at said tip, and means are provided to alter the focusing of the light emitted by LEDs (light emitting diodes), so the light can be more intensive in front of said device and hazier all around it. Means are provided to adjust the distribution of the haze-to-reflector ratio thereof.

### BRIEF DESCRIPTION OF THE DRAWINGS

Referring to the drawings:

FIG. 1 is a perspective view of a preferred embodiment of the invention as per the teachings of the invention.

FIG. 2 is the same modified.

FIG. 3 is a perspective view of another preferred embodiment of the invention as per the teachings of the invention, illustrating a focused light configuration.

FIG. 4 is another view of the same.

FIG. 5 is another view of the same, illustrating a diffuse light configuration.

FIG. 6 is yet another view of the same.

FIG. 7 is yet another view of the same, illustrating both the focused and the diffuse light emission of the device.

### DETAILED DESCRIPTION OF A PREFERRED EMBODIMENT

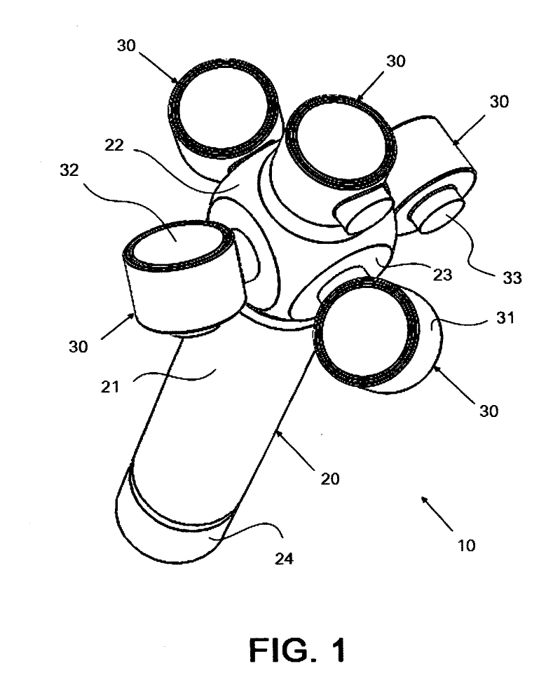

Attention is now turned to FIG. 1, which illustrates in a perspective view of a preferred embodiment of the invention, Torch 10.

Torch 10 has Body 20 and Reflectors 30. Body 20 has housing 21, head 22 with faces 23, and socket 24. Reflector 30 has casing 31, glass 32, and button 33.

Housing 21 encloses a battery pack, driver electronics for the LEDs and a main power switch, which may be integrated with socket 24 as a twist knob or push button.

Head 22 has directional faces 23 pointing forward (on the top) and sideways (on the four sides) to which Reflectors 30 are attached.

Casing 31 can be twisted around by less than 360°, so internal wiring would not be hurt by a full turn twist. Button 33 on the bottom of casing 31 may be a twist around knob or a push button switch, which would turn on the light on an individual reflector 30. The light then would shine though glass 32, which may be a lens, designed to focus that light.

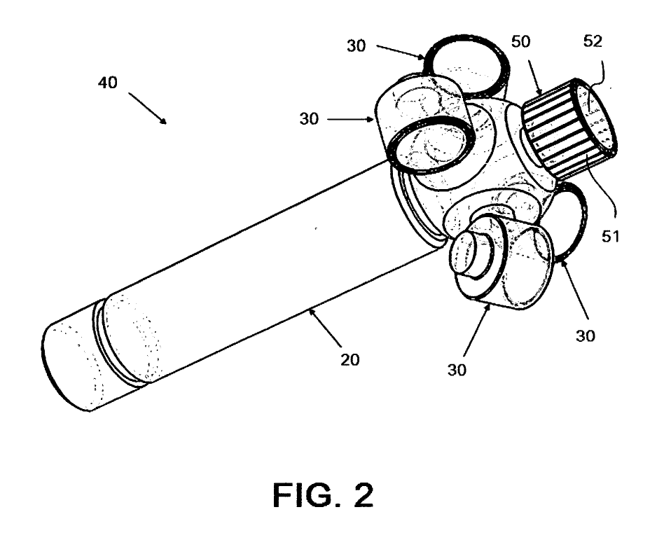

Attention is now turned to FIG. 2, which illustrates in a perspective view of another preferred embodiment of the invention, Torch 40.

Torch 40 is the same as Torch 10, except that the frontal Reflector 30 is replaced with Reflector 50, which has casing 51 configured as a twist knob, which turns on the light to shine through glass 52.

Reflectors 30 and 50 have their own LED light sources and are switchable individually. That facilitates the search with torch light, when the user want to see strong light ahead and also in some other selected direction(s).

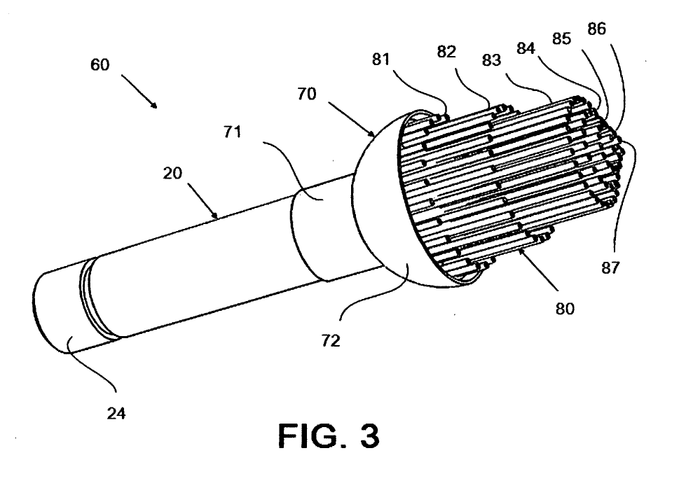

Attention is now turned to FIG. 3, which illustrates in a perspective view of yet another preferred embodiment of the invention, Torch 60.

Torch 60 has Body 20, Sleeve 70 and light guide Hair 80. Body 20 has socket 24, but no head 22. Instead, it has Sleeve 70, which retract on Body 20 and preferably snaps in either pushed out or pulled back.

Pushed out, as shown, it collimates Hair 80. Pulled back, it spreads it.

Hair 80 has a multiplicity of filaments, which guide light and preferably made of flexible transparent plastic attached to a common ball shape stem, which is also made of the same material. Said filaments are either solid or hollow (tubes) and arranged in layers. Notably, of 1^{st} layer 81, 2^{nd} layer 82, 3^{rd} layer 83, 4^{th} layer 84, 5^{th} layer 85, 6^{th} layer 86 and, finally 7^{th} layer 87.

Collimated as shown, all filaments 80 point forward and thus torch 60 shines light predominantly forward in this setting, letting some diffuse light to escape sideways nevertheless.

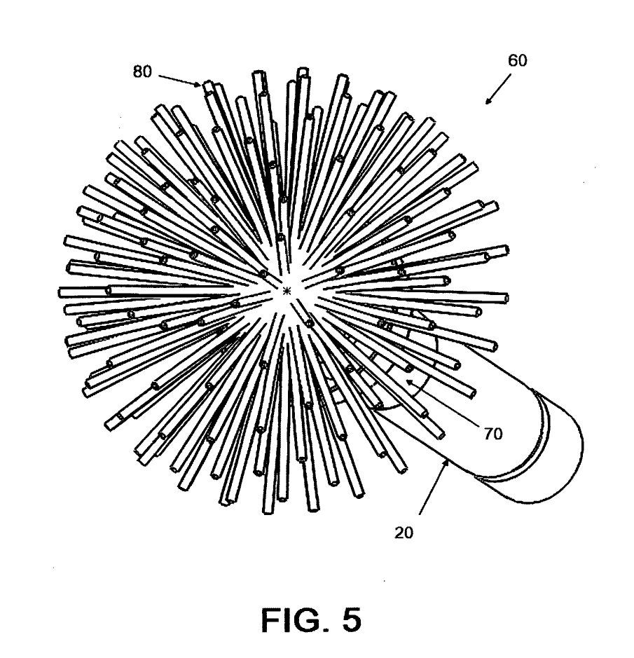

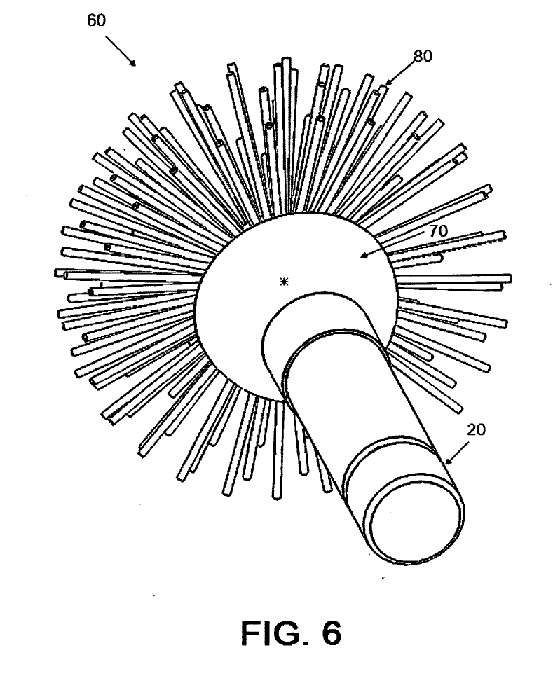

In another setting however, shown in FIGS. 5 and 6 further on, all the light passing through Hair 80 are diffuse, spreading to all direction forward and sideways, but to backward.

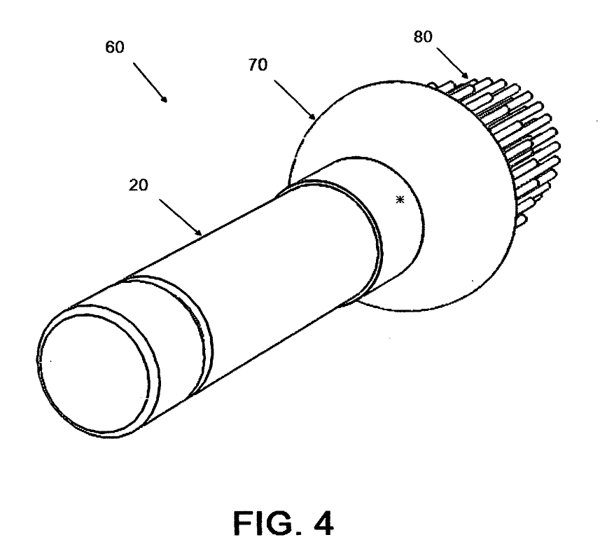

FIG. 4 illustrates Torch 60 from another perspective.

FIG. 5 illustrates Torch 60 in open hair setting for diffuse light searching. FIG. 6 illustrates the same from another perspective.

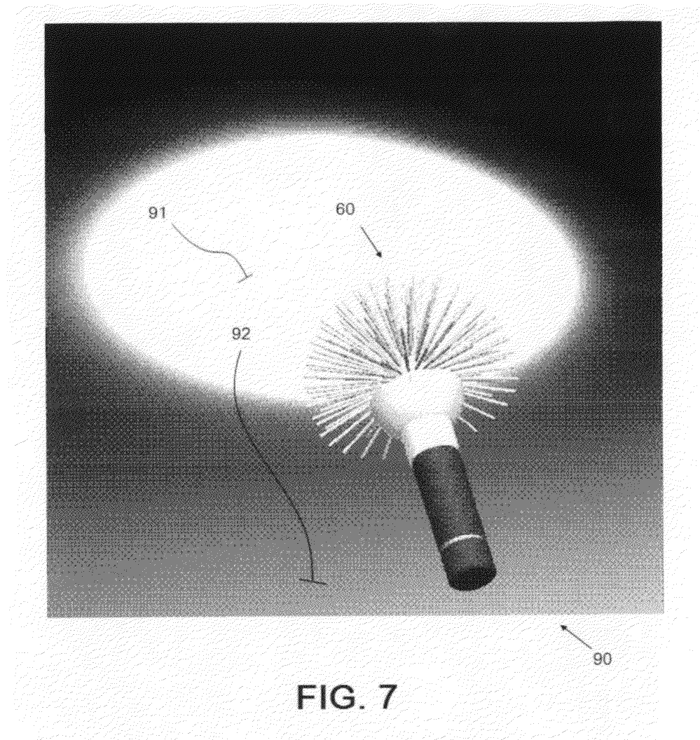

The light pattern of such a diffuse light searching is illustrated finally in FIG. 7 by light intensity picture 90.

Intense light circle 91 points forward and haze 92 is points all around behind circle 91. This is more natural to searching than one reflector light pointing forward in a narrow angle, as that is the case with state of art search lights.

The present invention is described above with reference to a preferred embodiment. However, those skilled in the art will recognize that changes and modifications may be made in the described embodiment without departing from the nature and scope of the present invention. For instance, torch bodies other than cylindrical are obvious configuration modification and thus is considered within the scope of this invention. Color light and color switching light torch, as well as light dimming modifications are also considered obvious and instructive over the teaching of the invention.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Electrical hand held and battery operated searchlight torch, having means to shine at least part of its emitted light away from a single direction and thereby shine light at least more than one direction forward.

2. Torch as per claim 1, having individually adjustable and switchable reflector heads, at least one of which can shine light away from forward.

3. Torch as per claim 1, having collectively adjustable transparent flexible light guides, having at least the following settings: A) collimated forward, and B) spread forward diffuse.
